(19) United States
(12) Patent Application Publication
(10) Pub. No.: US 2012/0180440 A1
(43) Pub. Date: Jul. 19, 2012

(54) Center Pivot Swingarm for Racehorse Harness

(76) Inventor: Hans K. Rynningen, El Cajon, CA (US)

(21) Appl. No.: 13/185,938

(22) Filed: Jul. 19, 2011

Related U.S. Application Data
(60) Provisional application No. 61/365,704, filed on Jul. 19, 2010.

(51) Int. Cl. B68B 1/00

(52) U.S. Cl. 54/71; 54/2

(57) ABSTRACT

A center pivot swingarm for racehorse harnesses is disclosed: In one preferred embodiment of the present invention a horse harness comprises a saddle for extending around the sides and the top of a horse, the saddle having a topmost portion, a swingarm having a top portion connecting a pair of arms extending in opposing directions around the sides and the top of the horse, over the saddle, the top portion of the swingarm is pivotally connected to the topmost portion of the saddle to enable the saddle to rotate relative to the swingarm, and a pair of hitches, each hitch formed as part of, or connected to, each of the pair of arms, for connecting with a shaft of a sulky or cart; in another embodiment of the present invention, a method of transmitting force between a sulky or a cart to a horse is disclosed; in another embodiment a method of training horses or horseracing is disclosed.

### CROSS REFERENCE TO RELATED APPLICATIONS

This application claims priority to U.S. Provisional Application Ser. No. 61/365,704 filed on Jul. 19, 2010 and incorporates the application by reference in its entirety as if specifically set forth herein.

### FEDERAL SPONSORED RESEARCH

Not Applicable

### SEQUENCE LISTING OR PROGRAM

Not Applicable

### BACKGROUND OF THE INVENTION

1. Field of the Invention

This invention relates racehorse harnesses, in particular a center pivot swingarm for racehorse harnesses.

2. Discussion of Prior Art

Harness or sulky racing involves a race horse pulling a sulky or cart with the driver being seated within the cart. Typically, the cart is lightweight being designed for racing and comprises a frame having two wheels and a driver's seat attached thereto. Two shafts extend from or form part of the frame, creating an opening therebetween within which the race horse is positioned. A harness attaches the shafts of the sulky to the horse.

On a conventional harness, the hitches for the shafts of the sulky or cart are mounted directly to the harness with leather or nylon straps, these can stretch and create an uneven push and pull on the shafts, this, in turn, can irritate and restrict the movement of the horse.

Today's modern race bikes (sulkies) are designed to push and lift the horse using the weight of the driver placed behind the wheels. The current hitches will stretch with the weight applied, and in the turns you get an uneven push and pull on the shafts.

The conventional harness mounts are akin to pushing a cart having wheels that do not pivot. When someone attempts to turn the cart, a significant amount of force is expended in dragging the fixed wheels through the turn. Currently there is need to improve efficiency by allowing the sulky or cart and its arms to pivot relative to the horse to reduce the pushing or dragging of the wheels of the sulky or cart as the horse and sulky or cart make a turn.

### OBJECTS OF THE INVENTION

It is an object of the present invention to mitigate the uneven push and pull on a sulky or cart resulting from rigidly fixing the shafts to the harness

It is another object of the present invention to improve efficiency by allowing the sulky or cart and its arms to pivot relative to the horse.

It is another object of the present invention to reduce the pushing or dragging of the wheels of the sulky or cart as the horse and sulky or cart make a turn.

### SUMMARY OF THE INVENTION

The present invention may be embodied as a center pivot swingarm for racehorse harnesses.

In one preferred embodiment of the present invention a horse harness comprises:

a saddle for extending around the sides and the top of a horse, the saddle having a topmost portion,

a swingarm having a top portion connecting a pair of arms extending in opposing directions around the sides and the top of the horse, over the saddle, the top portion of the swingarm is pivotally connected to the topmost portion of the saddle to enable the saddle to rotate relative to the swingarm, and

a pair of hitches, each hitch formed as part of, or connected to, each of the pair of arms, for connecting with a shaft of a sulky or cart.

In another embodiment of the present invention, a method of transmitting force between a sulky or a cart to a horse comprises the steps of:

providing a harness, the harness including a saddle and a swingarm, the saddle extending around the sides and the top of the horse and having a topmost portion, the swingarm having a top portion connecting a pair of arms extending in opposing directions around the sides and the top of the horse, over the saddle, the top portion of the swingarm is pivotally connected to the topmost portion of the saddle to enable the saddle to rotate relative to the swingarm, and the swingarm having a pair of hitches, each hitch formed as part of, or connected to, each of the pair of arms, for connecting with a shaft of a sulky or cart;

applying the harness to the horse,

connecting a pair of shafts of the sulky or cart with the pair of hitches,

applying a force to the saddle,

transferring the force between the saddle and a single point, and

transferring the force between the single point through each of the pair of arms and each of the pair of shafts of the sulky or cart.

In another preferred embodiment, the step of transferring the force from the single point to the saddle includes transferring the force through a pivot pin, bolt or trunion connecting the saddle to the saddle to the swingarm.

Another preferred embodiment of the present invention includes a method of training horses or horseracing comprising the steps of:

providing a horse, a sulky, a swingarm, a saddle, and a sulky driver, the sulky comprises a frame having two wheels and a driver's seat attached thereto, two shafts extend from or form part of the frame, creating an opening therebetween within which the horse is positioned, the saddle affixed to the horse extending around the sides and the top of the horse and having a topmost portion,

fixing the shafts of the sulky or cart to the swingarm,

locating the sulky driver on the driver's seat,

transmitting force from a single location of the saddle to the shafts of the sulky or cart, thereby moving the cart.

By mounting the hitch for the shafts directly to the swingarm, all the force of the shafts are transferred to the center pivot that, in turn delivers an even pressure back to the shafts. This allows for unsurpassed tracking of the wheels of the cart (sulky), a tremendous benefit, especially in the turns. It also offers a much smoother and comfortable ride for the horse and driver.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 shows a front view the inventive harness according to one embodiment of the present invention.

FIG. 2 shows a top view of a sulky or cart.

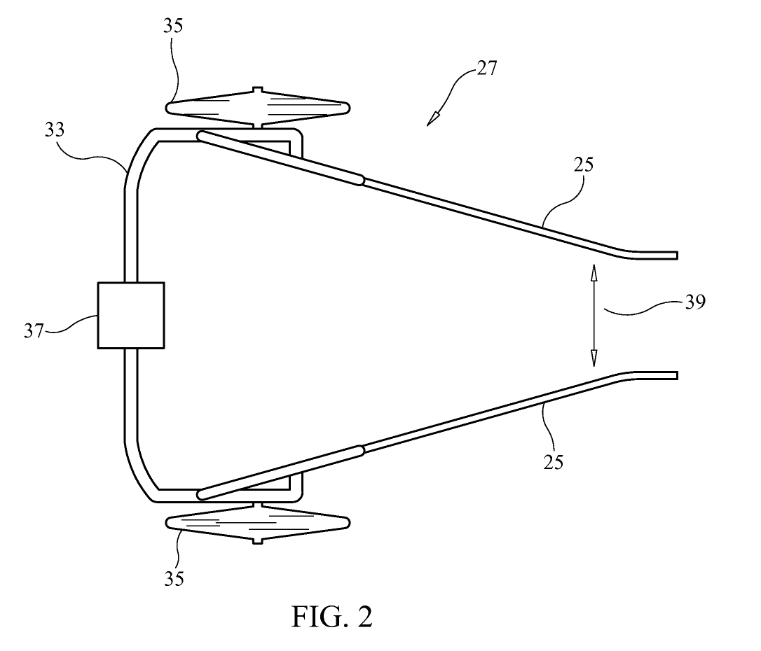

### DETAILED DESCRIPTION

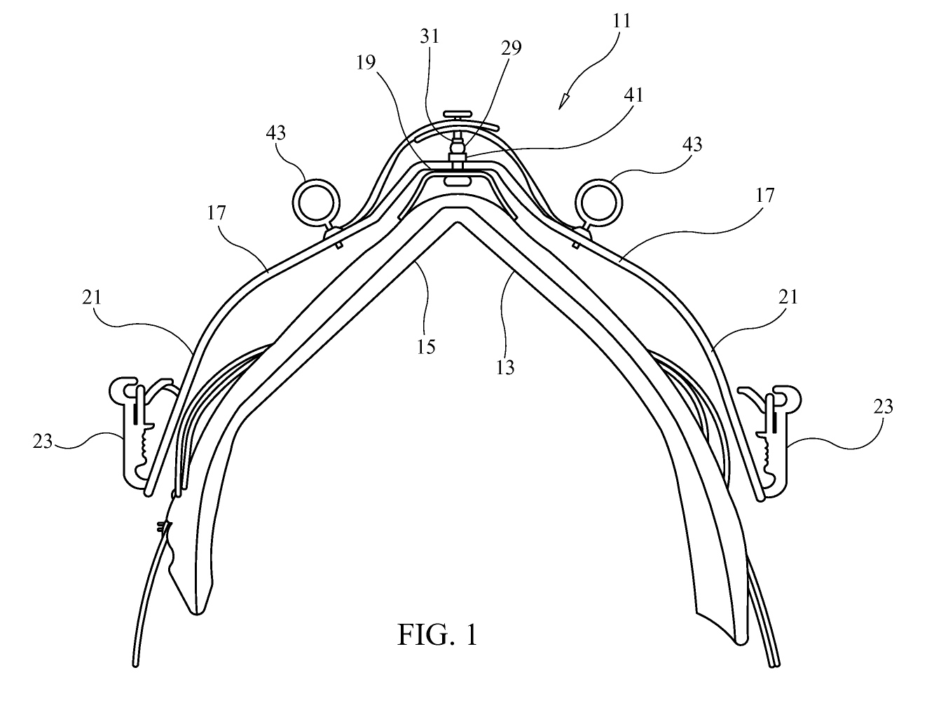

Turning to FIG. 1, there is shown a horse harness 11 comprising a saddle 13 pivotally connected to a swingarm 17. The saddle 13 is adapted for extending around the sides and the top of a horse, the saddle 13 having a topmost portion 15.

The swingarm 17 includes a top portion 19 connecting a pair of arms 21 extending in opposing directions around the sides and the top of the horse, over the saddle 13. The top portion 19 of the swingarm 17 is pivotally connected to the topmost portion 15 of the saddle 13 to enable the saddle 13 to rotate relative to the swingarm 17.

The swingarm 17 further includes a pair of hitches 23, each hitch formed as part of, or connected to, each of the pair of arms 21, for connecting with a shaft 25 of a sulky or cart 27.

In a preferred embodiment the invention further includes a pivot bolt 29 for pivotally connecting the top portion 19 of the swingarm 17 with the topmost portion 15 of the saddle 13. The pivot bolt 29 connecting the swingarm 17 to the saddle 13, may range from 0.5″ to 6″ long. Alternately, the pivot bolt 29 may be a pivot pin or trunion, or an alternative structure sufficient to transfer force from the swingarm 17 to a single location 31 of the saddle 13. Alternately, the structure connecting the swingarm 17 to the saddle 13 may form a ball type hitch that can mate with a coupler that mates with one or more shafts 25 of the sulky or cart 27. Alternately, the structure connecting the swingarm 17 to the saddle 13 may form a ball type hitch that can mate with a coupler attached to the swingarm 17.

The top portion 19 and pair of arms 21 of the swingarm 17 preferably are formed as a single piece. Preferably, the swingarm 17 is 30″ long, 1.5″ wide, 0.25″ thick high tension steel. Alternate materials may include, aluminum, polymers, fiberglass, or carbon fiber composites. The swingarm 17 may include two eyelet holes 43. Alternately, the swingarm 17 may range between 6″ and 56″ in length, and may range in width between 0.5″ and 8″ wide. Preferably, the swingarm rests on the pivot point 31 and is contoured and mounted over the saddle 13 of the harness 11.

My invention further includes a method of transmitting force between a sulky or a cart and a horse. The method comprises the steps of providing a harness 11, the harness 11 includes a saddle 13 and a swingarm 17. The saddle 13 extends around the sides and the top of the horse and has a topmost portion 15. The saddle 13 may be further secured to the horse using straps around the girth of the horse. The swingarm 17 has a top portion 19 connecting a pair of arms 21 extending in opposing directions around the sides and the top of the horse, over the saddle 13. The top portion 19 of the swingarm 17 is pivotally connected to the topmost portion 15 of the saddle 13 to enable the saddle 13 to rotate relative to the swingarm 17. The swingarm 17 further includes a pair of hitches 23, each hitch is formed as part of, or connected to, each of the pair of arms 21, for connecting with a shaft 25 of a sulky or cart 27. The harness is applied to the horse. A pair of shafts 25 of the sulky or cart 27 are fixed to the pair of hitches 23. A force is applied to the saddle 13. The force is then transferred between the saddle 13 and a single point 31. The force is then transferred between the single point 31 through each of the pair of arms 21 and each of the pair of shafts 25 of the sulky or cart 27. The force may be positive or negative, upwards or downwards depending on the action applied to the horse/cart 27.

In a preferred embodiment of the present invention, the step of transferring the force from the single point 31 to the saddle 13 includes transferring the force through a pivot pin 29, bolt 29 or trunion 29 connecting the saddle 13 to the saddle 13 to the swingarm 17.

My invention further includes a method of training horses or horseracing comprising the steps of providing a horse, a sulky, a swingarm 17, a saddle 13, and a sulky driver. The sulky comprises a frame 33 having two wheels 35 and a driver's seat 37 attached thereto. Two shafts 25 extend from or form part of the frame 33, creating an opening 39 therebetween within which the horse is positioned. The saddle 13 is fixed to the horse and extends around the sides and the top of the horse and has a topmost portion 15 located on the back of the horse. The sulky or cart 27 is fixed to the horse. The sulky driver takes position on the driver's seat 37, and the horse moves, thereby transmitting force from a single location 31 of the saddle 13 to the swingarm 17, to the shafts 25 of the sulky or cart 27, thereby moving the cart. In a preferred embodiment, the single location 31 is the top of the saddle 13.

In an embodiment of the invention, the method further includes the step of turning the horse and rotating the sulky or cart 27 about a pivot location 41 relative to the horse at the pivot location 41. In a preferred embodiment, the pivot location 41 is the top of the saddle 13.

While specific embodiments of the invention have been illustrated and described herein, it is realized that modifications and changes will occur to those skilled in the art. It is therefore to be understood that the appended claims are intended to cover all such modifications and changes as fall within the true spirit and scope of the invention.

1. A horse harness comprising:
a saddle for extending around the sides and the top of a horse, the saddle having a topmost portion,
a swingarm having a top portion connecting a pair of arms extending in opposing directions around the sides and the top of the horse, over the saddle, the top portion of the swingarm is pivotally connected to the topmost portion of the saddle to enable the saddle to rotate relative to the swingarm, and
a pair of hitches, each hitch formed as part of, or connected to, each of the pair of arms, for connecting with a shaft of a sulky or cart.

2. The harness of claim 1, further including a pivot bolt for pivotally connecting the top portion of the swingarm with the topmost portion of the saddle.

3. The harness of claim 1, wherein the top portion and pair of arms of the swingarm are formed as a single piece.

4. A method of transmitting force between a sulky or a cart to a horse comprising the steps of:
providing a harness, the harness including a saddle and a swingarm, the saddle extending around the sides and the top of the horse and having a topmost portion, the swingarm having a top portion connecting a pair of arms extending in opposing directions around the sides and the top of the horse, over the saddle, the top portion of the swingarm is pivotally connected to the topmost portion of the saddle to enable the saddle to rotate relative to the swingarm, and the swingarm having a pair of hitches, each hitch formed as part of, or connected to, each of the pair of arms, for connecting with a shaft of a sulky or cart;
applying the harness to the horse,
connecting a pair of shafts of the sulky or cart with the pair of hitches,
applying a force to the saddle,
transferring the force between the saddle and a single point, and
transferring the force between the single point through each of the pair of arms and each of the pair of shafts of the sulky or cart.

5. The method of claim 4, wherein the step of transferring the force from the single point to the saddle includes transferring the force through a pivot pin, bolt or trunion connecting the saddle to the saddle to the swingarm.

6. A method of training horses or horseracing comprising the steps of:
providing a horse, a sulky, a swingarm, a saddle, and a sulky driver, the sulky comprises a frame having two wheels and a driver's seat attached thereto, two shafts extend from or form part of the frame, creating an opening therebetween within which the horse is positioned, the saddle affixed to the horse extending around the sides and the top of the horse and having a topmost portion,
fixing the sulky or cart to the horse,
locating the sulky driver on the driver's seat,
transmitting force from a single location of the saddle to the shafts of the sulky or cart, thereby moving the cart.

7. The method of claim 6, wherein the single location is the top of the saddle.

8. The method of claim 7, further including the step of turning the horse and rotating the sulky or cart about a pivot location relative to the horse at the pivot location.

9. The method of claim 8, wherein the pivot location is the top of the saddle.
